(19) United States
(12) Patent Application Publication
(10) Pub. No.: US 2009/0078366 A1
(43) Pub. Date: Mar. 26, 2009

(54) MANUFACTURING METHOD OF OPTICAL SHEETS FOR DISPLAY

(75) Inventors: Keisuke Endo, Shizuoka (JP); Akihiko Takeda, Shizuoka (JP)

Correspondence Address: BIRCH STEWART KOLASCH & BIRCH, PO BOX 747, FALLS CHURCH, VA, 22040-0747, US

(73) Assignee: FUJIFILM Corporation, Tokyo (JP)

(21) Appl. No.: 12/066,483

(22) PCT Filed: Sep. 8, 2006
(86) PCT No.: PCT/JP2006/318312

§ 371 Date: May 23, 2008

(30) Foreign Application Priority Data
Sep. 12, 2005 (JP) 2005-264458

(51) Int. Cl. B32B 37/06; B32B 38/04

(52) U.S. Cl. 156/250; 156/272.8

(57) ABSTRACT

The present invention provides a fabrication method which promotes adhesion of sheet materials when bonding a plurality of optical sheets into a compound sheet and provides a manufacturing method of optical sheets suitable for liquid crystal display units and the like. A manufacturing method according to one aspect of the present invention includes a lamination step of laminating a plurality of optical sheets; and a bonding step of irradiating at least one or more spots on a laminate of the optical sheets prepared in the lamination step with a laser beam from one side of the laminate and thereby bonding the irradiated spots to obtain a compound optical sheet in which the plurality of optical sheets are integrated. Preferably, the method further includes a step of forming a photothermal conversion layer from a light absorber between the optical sheets to be fused. Incidentally, ultrasonic welding may be used instead of, or in combination with, laser welding.

### TECHNICAL FIELD

The present invention relates to a manufacturing method of optical sheets for displays. More particularly, it relates to a fabrication technique which makes it easy to assemble and handle display members used for liquid crystal display units and the like and which is suitable for manufacturing inexpensive high-performance optical sheets for displays.

### BACKGROUND ART

On portable notebook computers and portable phones equipped with a color liquid crystal display unit, portable liquid crystal television sets, player-equipped liquid crystal displays, and the like, high power consumption of the liquid crystal display units is one of the obstacles to extending battery time. These liquid crystal display units are mainly a backlight type which involves making a liquid crystal layer emit light by illuminating it from behind. In such backlight-type liquid crystal display units, a backlight unit is installed under the liquid crystal layer.

Generally, a backlight unit has a light source such as a cold-cathode tube and LED, an optical waveguide, and a plurality of optical sheets. Available optical sheets include hologram sheets, polarizing sheets, antireflection sheets, partially light reflecting and partially light transmitting sheets, diffraction grating sheets, interference filter sheets, color filter sheets, light wavelength conversion sheets, light diffusion sheets, etc. Optical sheets incorporated into the backlight units of liquid crystal display units include, light diffusion sheets, lens sheets, etc.

Incidentally, to display still images and moving images clearly, it is necessary to improve luminance of the liquid crystal display unit. Possible means of achieving this include increasing light quantity of the light source, improving optical characteristics of the light diffusion sheets or lens sheets, and so on.

However, with the above-described products which use a liquid crystal display unit, there is a limit to available power because of the need to ensure extended use and there is only so much that the quantity of light from the light source can be increased. Among other things, the backlight used for the liquid crystal display unit accounts for a large proportion of the power consumption of the entire equipment, making it an important task to minimize the power consumption of the backlight in order to extend the available battery time for the equipment and increase the practical value of the above-described products.

However, it is not desirable if an attempt to reduce the power consumption of the backlight results in reduced luminance of the backlight because then it will become difficult to see the liquid crystal display. To deal with this problem, optical sheets for displays intended to improve optical efficiency of backlight have been proposed as a means of improving the luminance of liquid crystal display units without increasing the power consumption of the backlight unit (Japanese Patent Application Laid-Open No. 7-230001, Japanese Patent No. 3123006, and Japanese Patent Application Laid-Open No. 5-341132).

### DISCLOSURE OF THE INVENTION

### Problems to be Solved by the Invention

Japanese Patent Application Laid-Open No. 7-230001, Japanese Patent No. 3123006, and Japanese Patent Application Laid-Open No. 5-341132 propose a light diffusion sheet which diffuses light from a light source such as an optical waveguide, lens sheet which condenses light in the front direction, or an optical sheet which integrates functions of a light diffusion sheet and lens sheet. Even trivial flaws on the front or back side stand out and make the lens sheet unusable, and thus a protective sheet is used to prevent such flaws.

This gives a cost disadvantage due to increases in the numbers of protective-sheet bonding processes and materials. Also, there are problems not only in terms of costs, but also in terms of quality because when a lens sheet is placed and a protective sheet is separated in a backlight assembly process, separation electrification can cause minute dust in the surroundings to adhere to lens sheet surfaces, resulting in flaws.

The present invention has been made in view of the above circumstances and has an object to provide a fabrication method which improves adhesion processing of sheet materials when bonding a plurality of optical sheets such as light diffusion sheets and lens sheets together into a compound sheet, in order to reduce bending of optical sheets which are liable to bend if handled singly in the backlight assembly process and the like so that the optical sheets will be easier to handle and in order to do away with a separation process by eliminating the need for a surface protection sheet and thereby prevent dust from adhering to the surfaces of the optical sheets as a result of separation electrification.

### Means for Solving the Problems

To achieve the above object, the present invention provides a manufacturing method of optical sheets for displays, comprising: a lamination step of laminating a plurality of optical sheets; and a bonding step of irradiating at least one or more spots on a laminate of the optical sheets prepared in the lamination step with a laser beam from one side of the laminate and thereby bonding the irradiated spots to obtain a compound optical sheet in which the plurality of optical sheets are integrated.

The present invention laminates two or more optical sheets, irradiates at least one spot on the laminate of the optical sheets with a laser beam from the front side, the back side, or both sides, and thereby welds the sheets together. This produces a compound optical sheet in which the plurality of optical sheets are integrated. The “optical sheet” is a generic name of various sheets which have optical functions and is typified by diffusion sheets, polarizing sheets, lens sheets, and the like.

According to one aspect of the present invention, the manufacturing method may comprise a photothermal conversion layer forming step of forming a photothermal conversion layer from a light absorber between the optical sheets bonded by irradiation with the laser beam.

According to this aspect, the light absorber superimposed between the optical sheets generates heat by absorbing the laser beam, and thereby efficiently provides thermal energy needed for welding. The “light absorber” is a material with a higher light absorption efficiency than the plurality of optical sheets. Available light absorbers include, for example, a black pigment containing carbon black, and organic pigments.

According to another aspect, the present invention provides a manufacturing method of optical sheets for displays, comprising: a lamination step of laminating a plurality of optical sheets; and a bonding step of pressing a horn against at least one or more spots on a laminate of the optical sheets prepared in the lamination step from one side of the laminate and thereby bonding the spots to obtain a compound optical sheet in which the plurality of optical sheets are integrated.

This aspect of the present invention laminates two or more optical sheets, applies a horn of an ultrasonic welder at least one spot on the laminate of the optical sheets from the front side, the back side, or both sides, and thereby welds the sheets together. This produces a compound optical sheet in which the plurality of optical sheets are integrated.

Preferably, the manufacturing method comprises a step of raising and lowering a base block placed in opposing relation to the horn using a base block up/down mechanism if necessary.

For example, the base block is raised into contact with the laminated sheets during a welding process by means of an ultrasonic horn and it is lowered to a predetermined retracted position clear of the sheets to wait during transport of the sheets.

According to one aspect of the present invention, the “plurality of optical sheets” are two or more optical sheets including at least one light diffusion sheet and at least one lens sheet.

Incidentally, the “lens sheet” is typified by a lenticular lens and prism sheet, where the lenticular lens consists of convex lenses formed adjacent to each other in one axial direction over almost an entire surface. Also, lens sheets include a diffraction grating and the like.

According to another aspect of the present invention, each of the plurality of optical sheets has a planar size larger than product size, and the manufacturing method further comprises a cutting step of cutting the compound optical sheet obtained in the bonding process into the product size.

This aspect makes it possible to eliminate the process of cutting a number of optical sheets separately into the product size. Also, it eliminates the process of laminating multiple layers of films (sheets) by positioning them. Furthermore, it eliminates the above-described problem with the protective sheet. Besides, it is advantageous in terms of costs and quality. Thus, the present invention makes it possible to produce high-quality optical sheets for displays at low costs using simpler processes than conventional methods.

According to another possible aspect of the present invention, it is conceivable to bond a plurality of optical sheets by a combination of the bonding methods according to the present invention—the bonding method using laser irradiation and the bonding method using an ultrasonic welder.

### ADVANTAGES OF THE INVENTION

The integration of optical sheets into a compound optical sheet according to the present invention eliminates the need for protective sheets for lens sheets, resulting in reduced material costs. Also, this reduces the number of operations needed to mount members during backlight assembly, resulting in reduced labor costs. Furthermore, it prevents dust adhesion caused by separation electrification which occurs when the protective sheets are removed.

Also, the present invention eliminates the need to purchase a lens sheet and light diffusion sheet separately. This reduces management costs for distribution and storage. Besides, the lens sheet and light diffusion sheet, which are soft and flabby, have poor handleability when handled singly, but when they are combined by the method of the present invention, the hardness of their outer edges are increased, resulting in increased working efficiency.

### BRIEF DESCRIPTION OF THE DRAWINGS

FIG. 1 is a sectional view of an embodiment of an optical sheet for displays produced by a manufacturing method of optical sheets for displays according to the present invention;

FIG. 2 is a sectional view of another embodiment of an optical sheet;

FIG. 3 is a sectional view of still another embodiment of an optical sheet;

FIG. 4 is a sectional view of still another embodiment of an optical sheet;

FIG. 5 is a sectional view of still another embodiment of an optical sheet;

FIG. 6 is a sectional view of still another embodiment of an optical sheet;

FIG. 7 is a side view illustrating a manufacturing method which employs laser welding;

FIG. 8 is a block diagram of a laser gun;

FIG. 9 is a top view of bonded optical sheets;

FIG. 10 is perspective view showing an example of laser welding;

FIG. 11 is side view showing an example of laser welding;

FIG. 12 is perspective view showing an example of blanking;

FIG. 13 is a block diagram showing a first example of a production line for optical sheets for displays;

FIG. 14 is a block diagram showing a second example of a production line for optical sheets for displays;

FIG. 15 is a block diagram showing a third example of a production line for optical sheets for displays;

FIGS. 16A and 16B are diagrams illustrating a planar layout of sheets blanked from a laminate on the production line for optical sheets for displays illustrate in FIG. 13;

FIGS. 17A and 17B are diagrams illustrating a planar layout of sheets blanked from a laminate on the production lines for optical sheets for displays illustrated in FIGS. 14 to 15;

FIG. 18 is a block diagram of an ultrasonic welder;

FIG. 19 is a block diagram showing a fourth example of a production line for optical sheets for displays;

FIG. 20 is side view showing an arrangement of the ultrasonic welding head and base block (anvil) shown in FIG. 19;

FIG. 21 is a plan view showing an example of welding performed by the welding head shown in FIG. 19;

FIG. 22 is a block diagram showing a fifth example of a production line for optical sheets for displays;

FIG. 23 is a chart showing composition of a resin solution used for fabrication of a prism sheet; and

FIG. 24 is a block diagram of prism sheet manufacturing equipment.

### DESCRIPTION OF SYMBOLS

10, 20, 30, 40 . . . Optical sheets for displays
12 . . . First diffusion sheet
14 First prism sheet
16 . . . Second prism sheet
18 . . . Second diffusion sheet
24 . . . Laser head
48 . . . Press
62, 64, 66 . . . Ultrasonic horn
72, 74, 76, 78 . . . Laser head
138 . . . Laser head
220 . . . Ultrasonic welder
228 . . . Ultrasonic horn
230 . . . Ultrasonic welding head
232 . . . Anvil (base block)

### BEST MODE FOR CARRYING OUT THE INVENTION

Embodiments of the present invention will be described below with reference to the drawings. First, description will be given of compositions of examples (first to sixth embodiments) of an optical sheet for displays produced by a manufacturing method of optical sheets for displays according to the present invention. Then, description will be given of the manufacturing method of optical sheets for displays.

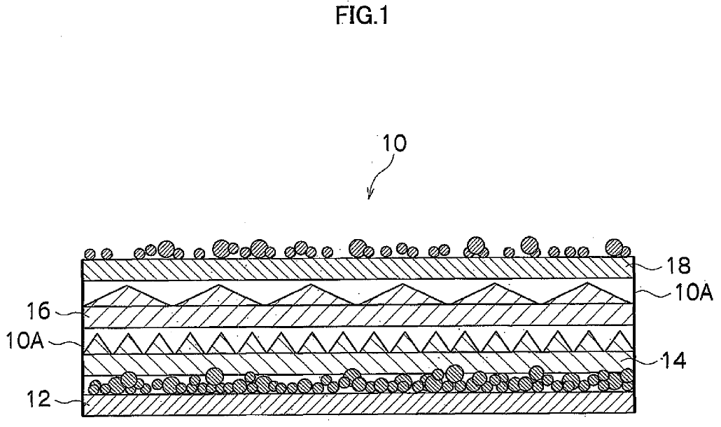

FIG. 1 is a sectional view showing composition of an example (first embodiment) of an optical sheet for displays produced by the manufacturing method of optical sheets for displays according to the present invention.

The optical sheet 10 for displays is an optical sheet module consisting of a first diffusion sheet 12, a first prism sheet 14, a second prism sheet 16, and a second diffusion sheet 18 laminated in this order from the bottom.

The first diffusion sheet 12 and second diffusion sheet 18 consist of a transparent film (backing) with beads bound to a surface (one side) by a binder. They have predetermined light diffusion performance. The first diffusion sheet 12 and second diffusion sheet 18 differ in bead diameter (average grain size) as well as in light diffusion performance.

The transparent film (backing) used for the first diffusion sheet 12 and second diffusion sheet 18 may be a resin film. Known materials are available for the resin film, including polyethylene, polypropylene, polyvinyl chloride, polyvinylidene chloride, polyvinyl acetate, polyester, polyolefin, acrylic, polystyrene, polycarbonate, polyamide, PET (polyethylene terephthalate), biaxially-stretched polyethylene terephthalate, polyethylene naphthalate, polyamide-imide, polyimide, aromatic polyamide, cellulose acylate, cellulose triacetate, cellulose acetate, cellulose acetate propionate, and cellulose diacetate. Among these materials, polyester, cellulose acylate, acrylic, polycarbonate, and polyolefin are particularly preferable.

The bead diameter for the first diffusion sheet 12 and second diffusion sheet 18 must be 100 μm or less. Preferably, it is 25 μm or less. This can be achieved, for example, by using an average grain size of 17 μm in a predetermined distribution range of 7 to 38 μm.

The first prism sheet 14 and second prism sheet 16 consist of convex lenses formed adjacent to each other in one axial direction over almost an entire surface. The spacing between the lenses can be set to 50 μm, peak-to-valley height can be set to 25 μm, and apical angle of peaks can be set to 90 degrees (right angle).

The first prism sheet 14 and second prism sheet 16 are oriented in such a way that axes of their convex lenses (prisms) will be orthogonal to each other. Specifically, in FIG. 1, the axes of the convex lenses on the first prism sheet 14 are oriented in the direction perpendicular to the plane of the paper while the axes of the convex lenses on the second prism sheet 16 are oriented in the direction parallel to the plane of the paper. Incidentally, in FIG. 1, the second prism sheet 16 is shown as being oriented in a direction different from their actual direction to show that the second prism sheet 16 has a profile shaped like convex lenses.

Various known materials and manufacturing methods are applicable to the first prism sheet 14 and second prism sheet 16. For example, a resin-sheet manufacturing method which is available for use involves extruding sheet-like resin material through dies, squeezing the resin material between a transfer roller (with a negative pattern of the prism sheet formed on a surface) rotating at a speed approximately equal to the extrusion speed of the resin material and a nip roller placed opposite the transfer roller and rotating at the same speed, and thereby transferring projections or depressions on the transfer roller to the resin material.

Also available is a prism-sheet manufacturing method which involves laminating a pattern plate (stamper) and a resin plate by hot-pressing, where the pattern plate has a negative pattern of the prism sheet formed on its surface, and press-forming the prism sheet by heat transfer.

Resin materials used in these manufacturing methods include thermoplastic resins such as polymethyl methacrylate (PMMA resin), polycarbonate resin, polystyrene resin, MS resin, AS resin, polypropylene resin, polyethylene resin, polyester terephthalate resin, polyvinyl dichloride resin (PVC), thermoplastic elastomers, copolymers thereof and cycloolefin polymers.

Another available resin-sheet manufacturing method involves transferring a concavo-convex pattern from a surface of a concavo-convex roller (with a negative pattern of the prism sheet formed on a surface) to a surface of a transparent film (polyester, cellulose acylate, acrylic, polycarbonate, polyolefin, and the like) similar to the one used for the first diffusion sheet 12 and second diffusion sheet 18.

More specifically, a manufacturing method for a concavo-convex sheet is available which involves continuously feeding a transparent film on whose surface two or more adhesive and resin layers are formed by sequential application of an adhesive and resin (e.g., UV-curing resin), looping a transparent film over a concavo-convex roller, transferring a concavo-convex pattern to the resin layers from the surface of the concavo-convex roller, and thereby allowing the resin layers to harden (e.g., by UV irradiation) with the transparent film looped over the concavo-convex roller. Incidentally, the adhesive is not absolutely necessary.

Incidentally, manufacturing methods for the first prism sheet 14 and second prism sheet 16 are not limited to those described above, and any other method may be used as long as it can form a desired concavo-convex pattern on the surface.

As shown in FIG. 1, the layers of the optical sheet 10 for displays are integrated at the right and left edges via junctions 10A. The junctions 10A are formed by laser processing, ultrasonic welding, or a combination thereof in a bonding step.

The optical sheet 10 for displays is placed, for example, between a light source unit and liquid crystal cell so that they will together form a liquid crystal display element. This has the advantage of making an assembly operation of the liquid crystal display element easier in addition to the various advantages described above (capabilities to produce high-quality optical sheets for displays at low costs using simpler processes than conventional methods).

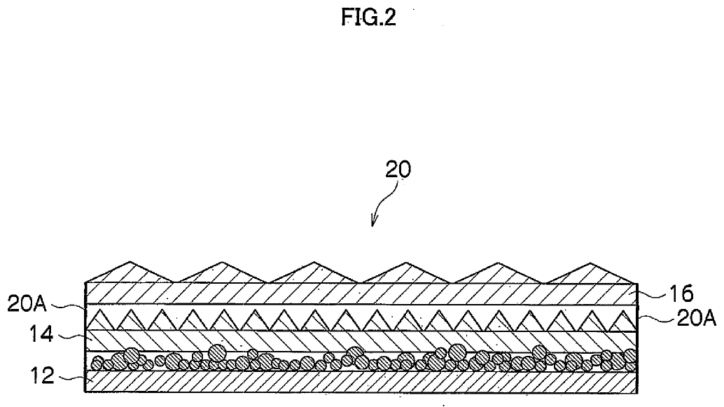

Next, description will be given of another example (second embodiment) of an optical sheet for displays produced by the manufacturing method of optical sheets for displays according to the present invention. FIG. 2 is a sectional view showing composition of an optical sheet 20 for displays. Incidentally, components identical with or similar to those in FIG. 1 (first embodiment) are denoted by the same reference numerals as the corresponding components in FIG. 1, and detailed description thereof will be omitted.

The optical sheet 20 for displays consists of the first diffusion sheet 12, first prism sheet 14, and second prism sheet 16 laminated in this order from the bottom. When wide diffusion such as that of the optical sheet 10 for displays is not required, the second diffusion sheet 18 is omitted.

The optical sheet 20 for displays is placed, for example, between a light source unit and liquid crystal cell so that they will together form a liquid crystal display element, as in the case of the first embodiment.

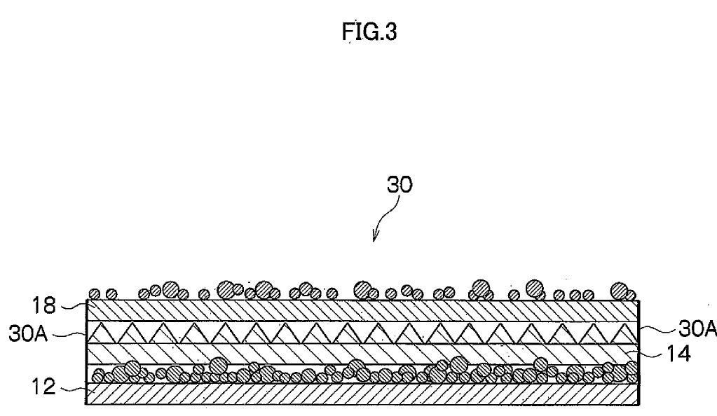

Next, description will be given of another example (third embodiment) of an optical sheet for displays produced by the manufacturing method of optical sheets for displays according to the present invention. FIG. 3 is a sectional view showing composition of an optical sheet 30 for displays. Incidentally, components identical with or similar to those in FIG. 1 (first embodiment) and FIG. 2 (second embodiment) are denoted by the same reference numerals as the corresponding components in FIGS. 1 and 2, and detailed description thereof will be omitted.

The optical sheet 30 for displays consists of the first diffusion sheet 12, first prism sheet 14, and second diffusion sheet 18 laminated in this order from the bottom.

In the optical sheet 30 for displays, when diffusion performance in the direction perpendicular to the plane of the paper such as that of the optical sheet 10 for displays is not required, the second prism sheet 16 is omitted.

The optical sheet 30 for displays is placed, for example, between a light source unit and liquid crystal cell so that they will together form a liquid crystal display element, as in the case of the first embodiment.

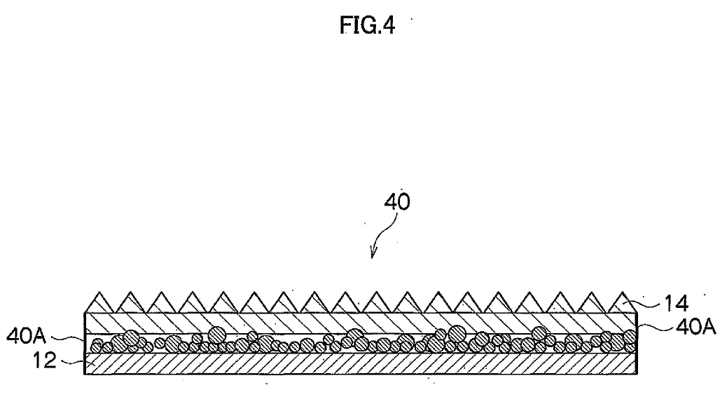

Next, description will be given of another example (fourth embodiment) of an optical sheet for displays produced by the manufacturing method of optical sheets for displays according to the present invention. FIG. 4 is a sectional view showing composition of an optical sheet 40 for displays. Incidentally, components identical with or similar to those in FIG. 1 (first embodiment) and FIG. 2 (second embodiment) are denoted by the same reference numerals as the corresponding components in FIGS. 1 and 2, and detailed description thereof will be omitted.

The optical sheet 40 for displays consists of the first diffusion sheet 12 and first prism sheet 14 laminated in this order from the bottom. When wide diffusion such as that of the optical sheet 10 for displays is not required, the second diffusion sheet 18 is omitted and when diffusion performance in the direction perpendicular to the plane of the paper such as that of the optical sheet 10 for displays is not required, the second prism sheet 16 is omitted.

The optical sheet 40 for displays is placed, for example, between a light source unit and liquid crystal cell so that they will together form a liquid crystal display element, as in the case of the first embodiment.

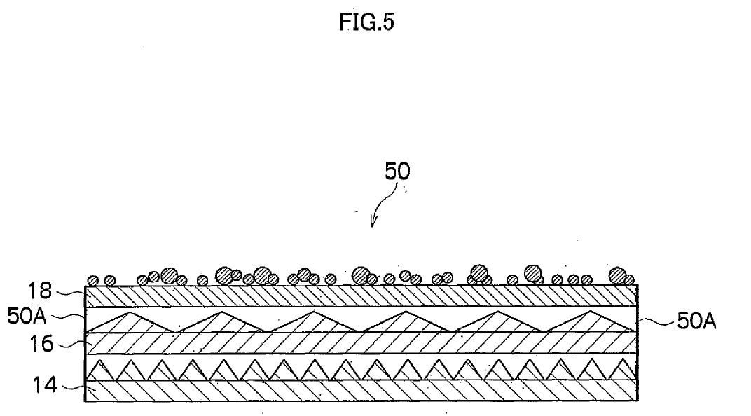

Next, description will be given of another example (fifth embodiment) of an optical sheet for displays produced by the manufacturing method of optical sheets for displays according to the present invention. FIG. 5 is a sectional view showing composition of an optical sheet 50 for displays. Incidentally, components identical with or similar to those in FIG. 1 (first embodiment) and FIG. 2 (second embodiment) are denoted by the same reference numerals as the corresponding components in FIGS. 1 and 2, and detailed description thereof will be omitted.

The optical sheet 50 for displays consists of the first prism sheet 14, second prism sheet 16, and second diffusion sheet 18 laminated in this order from the bottom. When wide diffusion such as that of the optical sheet 10 for displays is not required, the first diffusion sheet 12 is omitted.

The optical sheet 50 for displays is placed, for example, between a light source unit and liquid crystal cell so that they will together form a liquid crystal display element, as in the case of the first embodiment.

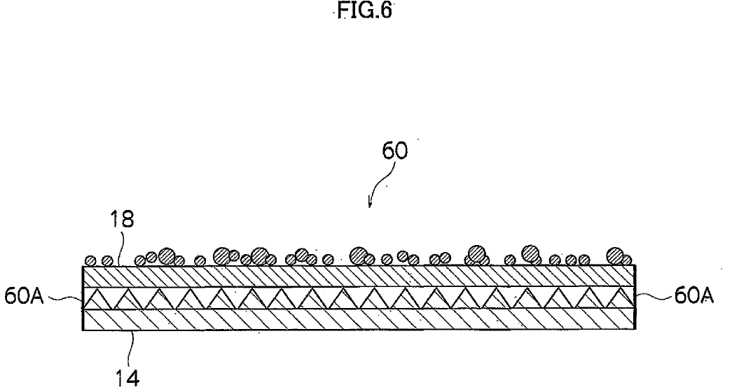

Next, description will be given of another example (sixth embodiment) of an optical sheet for displays produced by the manufacturing method of optical sheets for displays according to the present invention. FIG. 6 is a sectional view showing composition of an optical sheet 50 for displays. Incidentally, components identical with or similar to those in FIG. 1 (first embodiment) and FIG. 2 (second embodiment) are denoted by the same reference numerals as the corresponding components in FIGS. 1 and 2, and detailed description thereof will be omitted.

The optical sheet 60 for displays consists of the first prism sheet 14 and second diffusion sheet 18 laminated in this order from the bottom. When wide diffusion such as that of the optical sheet 10 for displays is not required, the first diffusion sheet 12 is omitted and when diffusion performance in the direction perpendicular to the plane of the paper such as that of the optical sheet 10 for displays is not required, the second prism sheet 16 is omitted.

The optical sheet 60 for displays is placed, for example, between a light source unit and liquid crystal cell so that they will together form a liquid crystal display element, as in the case of the first embodiment.

Next, description will be given of the manufacturing method of optical sheets for displays. The manufacturing method is commonly applicable to the optical sheets 10 to 60 for displays. For convenience of explanation, however, it is applied here to an optical sheet for displays consisting of two laminated layers.

[First Form of Manufacturing Method]

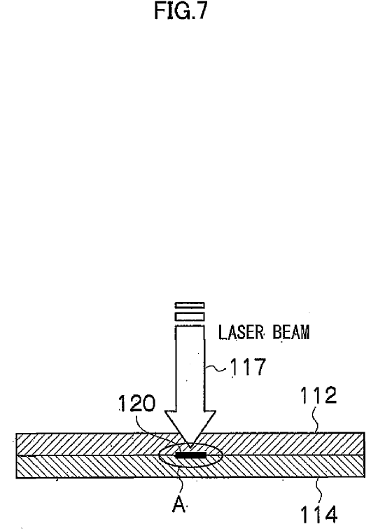

FIG. 7 is a side view illustrating a first form of the manufacturing method. The first manufacturing method, overlays a light diffusion sheet 112 and lens sheet 114 produced separately, irradiates them with a laser beam 117 from one side (top side in FIG. 7), and thereby bonds the irradiated part.

The light diffusion sheet 112 and lens sheet 114 prepared by known methods were used. In FIG. 7, the light diffusion sheet 112 was overlaid on the lens sheet 114 and an infrared laser beam 117 was directed from above at an area desired to be bonded.

To ensure reliable bonding, an infrared absorber 120 was applied as a photothermal conversion layer to an area (area encircled by an ellipse indicated by symbol A in FIG. 7) desired to be bonded between the sheets. The infrared absorber 120 used here was a black pigment (which corresponds to the “flight absorber”) containing carbon black with good infrared absorbency.

Instead of the black pigment, a pigment based on phthalocyanine, naphthalocyanine or other macrocyclic compound which absorbs visible to near-infrared regions may be used as the infrared absorber 120. Materials used for high-density laser recording media such as optical disks are also available because they generally absorb semiconductor laser beams strongly. Typical examples are organic dyes, including cyanine dyes such as indolenine dyes, anthraquinone-based, azulene-based, and phthalocyanine-based dyes, and dyes based on organometallic compounds such as dithiol nickel complexes.

In terms of appearance, preferably the photothermal conversion layer is as thin as possible. Thus, cyanine dyes and phthalocyanine-based dyes which have a large absorption constant at the wavelength of irradiating light are more preferable. Most preferably, a pigment or dye which absorbs infrared rays but transmits visible rays is applied to one or both sides of each sheet when forming the sheet.

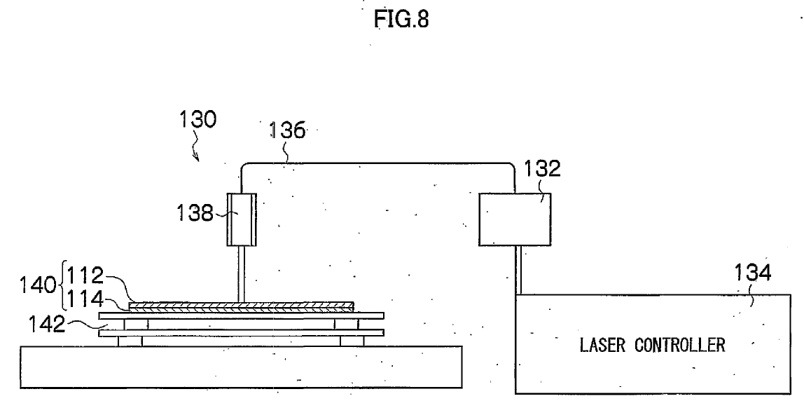

FIG. 8 is a block diagram of a semiconductor laser gun. The semiconductor laser gun 130 comprises a semiconductor laser oscillator 132, laser controller 134 which controls it, laser head 138 connected to the semiconductor laser oscillator 132 via optical fiber 136, and XY table 142 which supports laminated optical sheet 140 which is a subject of processing (workpiece).

The laser head 138 is equipped with a condenser lens (not shown) and light led by the optical fiber 136 is condensed by the condenser lens in the laser head 138 and directed at the laminate 140 on the XY table 142.

As an example of processing conditions, a laser beam with a power of 22 W and a diameter of 0.6 mm was emitted at a scanning speed of 112 mm/s using a semiconductor laser oscillator 132 with an oscillation wavelength of 808 nm. As a result, bonding was achieved without any problem in appearance, bonding strength, or optical performance.

By reversing the lamination order of the light diffusion sheet 112 and lens sheet 114 described with reference to FIG. 7, the light diffusion sheet 112 was placed face-down and the lens sheet 114 was placed face-down on top of it (i.e., the workpieces were reversed in FIG. 8) and a laser beam was emitted from above in the same manner as described above. Bonding was achieved similarly.

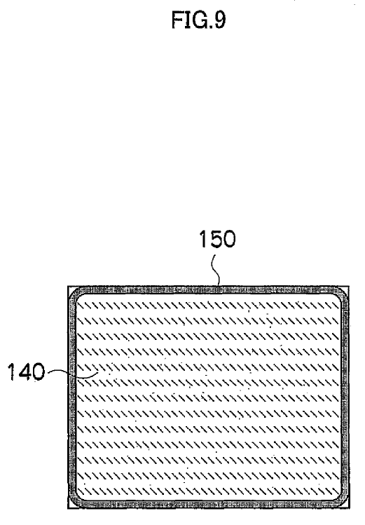

FIG. 9 is a top view of bonded optical sheets. A bonded area is indicated by symbol 150. In this example, all the edges of the rectangular sheets are bonded.

An infrared absorber was applied to the entire perimeter of the sheets to be bonded and the entire perimeter was bonded by being irradiated with a laser beam. Alternatively, only one spot or a desired side may be bonded or the optical sheets may be spot-bonded.

In any case, since only areas to which the infrared absorber is applied are bonded, if the infrared absorber is applied in spots, the sheet is bonded only in spots even if the entire perimeter is irradiated with a laser beam. That is, there is no need to turn on and off the laser beam intermittently.

Either continuous-wave laser or pulse laser may be used. Although in the above example, the optical sheets to be bonded were moved by the XY table 142 with the laser head 138 fixed, the laser head may be moved by fixing the optical sheets or both laser head and optical sheets may be moved in sync.

Although in the above example, a prism sheet was bonded with a light diffusion sheet laid over it, three or four sheets can be bonded by adjusting laser output and scanning speed as required.

The laminated optical sheets 140 may be bonded by laser irradiation in twice, from the front side and back side.

Next, a fabrication method by the combination of laser welding and blanking will be described. Although bonding of two optical sheets is illustrate here, more than two optical sheets can be bonded similarly.

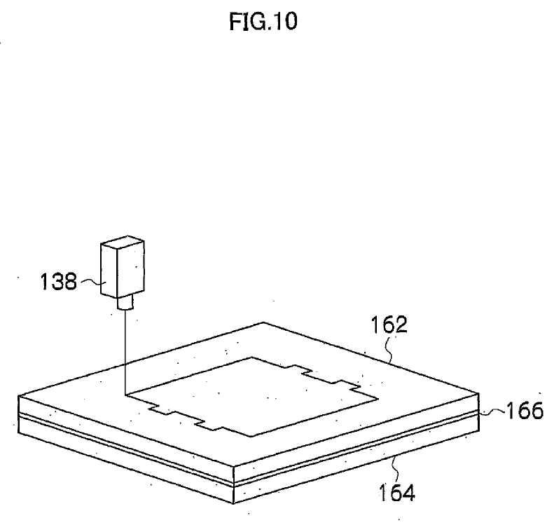

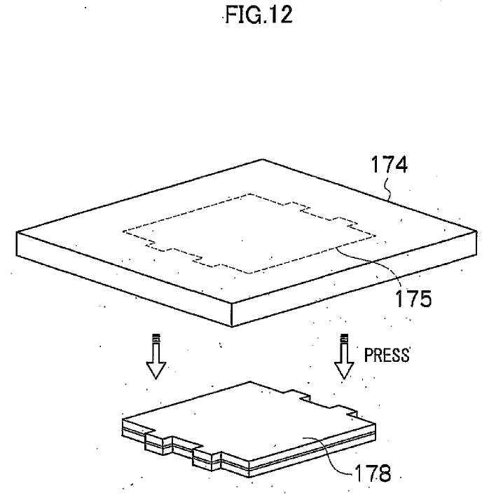

As shown in FIG. 10, two optical sheets 162 and 164 with a photothermal conversion layer 166 superimposed between them are laminated in tight contact. The laminate is scanned by the laser head 138, drawing a desired shape (the same shape as the blanking shape shown in FIG. 12).

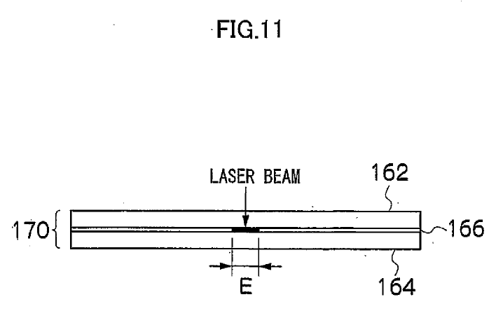

As shown in FIG. 11, that part E of the photothermal conversion layer 166 between the optical sheets 162 and 164 which is irradiated with the laser beam generates heat, thereby welding the optical sheets 162 and 164. In this way, the photothermal conversion layer 166 between the optical sheets 162 and 164 is made to generate heat by laser irradiation along the blanking shape, thereby welding inner surfaces of the optical sheets 162 and 164 and creating a compound optical sheet 170. Since welding takes place on the inner surfaces, this method has an advantage of providing a product free of damage to its front and back sides as well as of dust.

After the laser welding process, a desired shape is blanked using a Victoria die 174 as shown in FIG. 12. The Victoria die 174 may be, for example, a veneer in which a blade 175 approximately 23 tutu high is set according to the shape desired to be blanked.

The compound optical sheet 170 is set on a press in such a way that the Victoria die 174 will be aligned with the welding area of the compound optical sheet 170 illustrated in FIGS. 10 and 11 and sheets are blanked one after another to obtain optical sheets 178 of product size for displays. This process is followed by an accumulation process and packaging process.

### EXAMPLE 1 OF PRODUCTION LINE FOR OPTICAL SHEETS FOR DISPLAYS

Next, an example of a production line for optical sheets for displays will be described. The production line described below is commonly applicable to the optical sheets 10 to 60 for displays. For convenience of explanation, however, it is applied here to an optical sheet for displays consisting of four laminated layers (first embodiment).

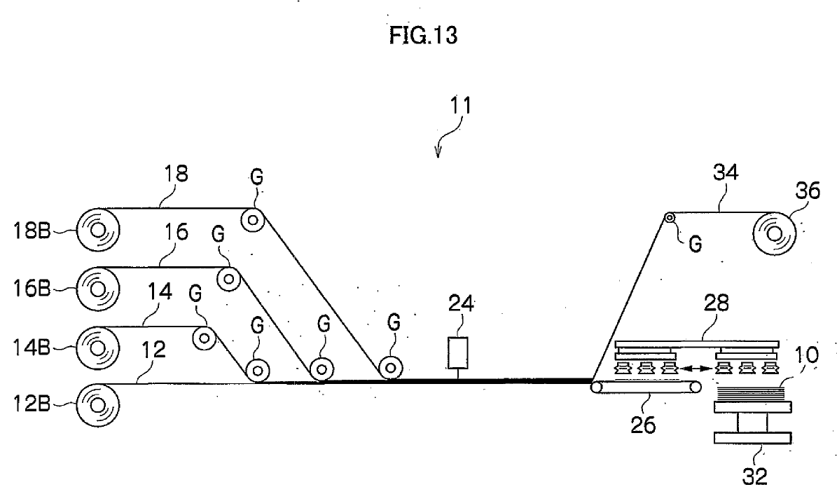

FIG. 13 is a block diagram of a production line 11 for optical sheets for displays. Rolls 12B, 14B, 16B, and 18B on the left side of FIG. 13 are rolls of the first diffusion sheet 12, first prism sheet 14, second prism sheet 16, and second diffusion sheet 18 in FIG. 1, respectively.

The rolls 12B, 14B, 16B, and 18B are supported about rotating shafts of respective feeding means (not shown) so that the first diffusion sheet 12, first prism sheet 14, second prism sheet 16, and second diffusion sheet 18 can be fed from the rolls 12B, 14B, 161B, and 188B, respectively, at approximately the same speeds.

The first diffusion sheet 12, first prism sheet 14, second prism sheet 16, and second diffusion sheet 18 are fed by being supported by respective guide rollers G and are eventually laminated upstream of a laser head 24 described later (lamination process).

Available laser guns including the laser head 24 are a YAG laser gun with a wavelength of 355 to 1064 nm, semiconductor laser gun, carbon dioxide laser gun with a wavelength of 9 to 11 μm, and the like. Regarding the type of oscillation, either continuous oscillation or pulse oscillation may be used, but pulse welding is preferable when carrying out welding almost simultaneously with cutting because of a good finished appearance.

Regarding the power and frequency needed to carry out welding (bonding process) almost simultaneously with cutting (cutting process), although they depend on the feed rate of material, scanning speed of a laser beam, thickness of the material, and the like, generally good results are obtained at a power of 2 to 50 W and a frequency of 100 kHz.

The laser head 24 is mounted on an X robot axis or XY robot axis which can move in an X direction (width direction of the sheet) or X-Y direction. It can be positioned at any desired position or move along any desired path. The laser head 24 itself may be moved according to a laser irradiation pattern, but travel mechanisms in the X-Y direction can be simplified if the laser beam is guided via an optical fiber with the laser head 24 fixed.

Incidentally, a known mechanism (suction device or the like) may be installed to suck smoke generated during cutting and welding by the laser head 24.

By directing a laser beam from the laser head 24 at a desired location on an edge of the laminate and moving a laser spot at a constant speed, the edges of the laminate are cut to product size, melted, and bonded.

The optical sheets 10 for displays (see FIG. 1) are produced through the above processes. After the cutting and bonding, the optical sheets 10 are transported on a conveyor 26. When the conveyor 26 stops, the optical sheets 10 on it are stacked one after another on an accumulation unit 32 by a horizontal transfer machine 28.

On the other hand, the laminate 34 of sheets remaining after the optical sheets 10 for displays are blanked by the laser head 24 is wound up by a wind-up roll 36 of a wind-up machine (whose details are not shown).

The manufacturing method (first manufacturing method) of optical sheets for displays provides the following advantages 1) to 3).

1) Reduction of Flaw-Induced Failures

Flaws on the top or bottom faces of the lens sheets (first prism sheet 14 and second prism sheet 16) tend to stand out due in part to lens effect. On the other hand, flaws on the bottom faces of the diffusion sheets (first diffusion sheet 12 and second diffusion sheet 18) do not stand out because of light diffusion. Thus, to reduce flaw-induced failures, it is important to damage to the lens sheets. Damage often occurs during handling after fabrication. By combining the lens sheets with the diffusion sheets, it is possible to reduce failures induced by flaws because the diffusion sheets serve as protective sheets. This effect is great especially in the case of the optical sheet 10 for displays according to the first embodiment (see FIG. 1) and optical sheet 30 for displays according to the second embodiment (see FIG. 3) because the lens sheets are not exposed.

2) Reduction in the Number of Assembly Processes

For example, in the assembly of a liquid crystal display element, if the optical sheet 10 for displays according to the first embodiment (see FIG. 1) is used, only one process for installing the optical sheet 10 for displays is required whereas if a conventional optical sheet is used, eight processes are required: namely, (i) installation of a first diffusion sheet, (ii) separation of a protective sheet from the back side of a first lens sheet, (iii) separation of a protective sheet from the front side of the first lens sheet, (iv) installation of the first lens sheet, (v) separation of a protective sheet from the back side of a second lens sheet, (vi) separation of a protective sheet from the front side of the second lens sheet, (vii) installation of the second lens sheet, and (viii) installation of a second diffusion sheet. In this way, the first manufacturing method can reduce the number of assembly processes greatly, resulting in reduction of product costs.

3) Reduction in the Number of Protective Sheets

Protective sheets are often pasted to lens sheets for protection from damage. The protective sheets are discarded after installation of the lens sheet and are very wasteful. By making the diffusion sheets combine protective sheets, the present invention makes it possible to reduce the number of protective sheets.

Specifically, one protective sheet can be slashed in the optical sheet 40 for displays according to the fourth embodiment (see FIG. 4) and optical sheet 60 for displays according to the sixth embodiment (see FIG. 6), two protective sheets can be slashed in the optical sheet 30 for displays according to the third embodiment (see FIG. 3), three protective sheets can be slashed in the optical sheet 20 for displays according to the second embodiment (see FIG. 2) and optical sheet 50 for displays according to the fifth embodiment (see FIG. 5), and four protective sheets can be slashed in the optical sheet 10 for displays according to the first embodiment (see FIG. 1).

### EXAMPLE 2 OF PRODUCTION LINE FOR OPTICAL SHEETS FOR DISPLAYS

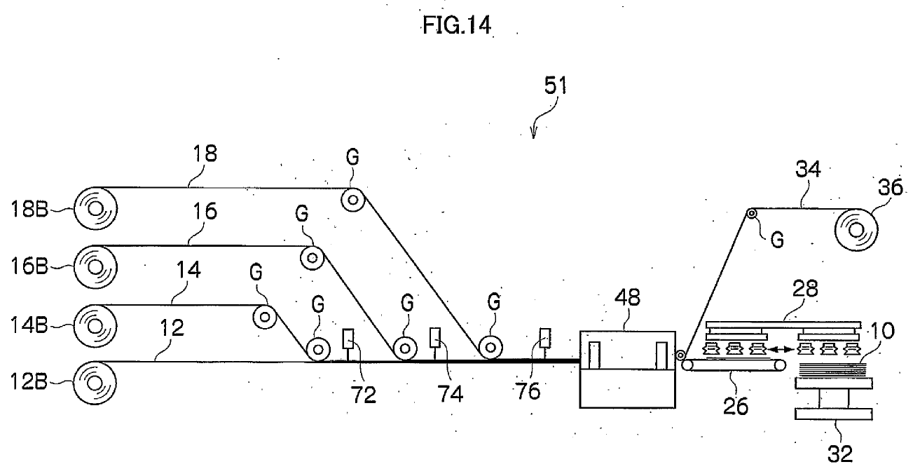

FIG. 14 is a block diagram showing a production line 51 for optical sheets for displays according to another embodiment. Incidentally, components identical with or similar to those of the production line 11 for optical sheets for displays in FIG. 13 are denoted by the same reference numerals as the corresponding components in FIG. 13, and detailed description thereof will be omitted.

The production line 51 for optical sheets for displays in FIG. 14 employs laser heads 72, 74, and 76 and press 48 (press unit) (see FIG. 14) instead of the laser head 24 of the production line 11 for optical sheets for displays in FIG. 13. The laser heads 72, 74, and 76 are installed downstream of press rollers (guide rollers G).

The laser heads 72, 74, and 76 are used to fuse two or more laminated sheets together. Specifically, the laser head 72 fuses the first diffusion sheet 12 and first prism sheet 14 together, the laser head 74 fuses the first prism sheet 14 and second prism sheet 16 together, and the laser head 76 fuses the second prism sheet 16 and second diffusion sheet 18 together.

Incidentally, unlike the laser head 24 of the production line 11 for optical sheets for displays in FIG. 13, the laser heads 72, 74, and 76 are used only in the bonding process while the cutting process is performed by the blanking press 48. However, basic specifications and peripheral configuration of the laser heads 72, 74, and 76 are approximately the same as in FIG. 13.

Conditions of the laser heads 72, 74, and 76 can be set such that the fused part will not be broken by heat and the bonded (fused) part may be cooled by blowing air from an air-cooling mechanism.

By making the blades of the blanking press 48 downstream of the laser heads 72, 74, and 76 pass through a central portion of the fused and bonded part, it is possible to bond edges on all or any desired sides of the blanked sheets (optical sheets 10 to 60 for displays) in the resulting compound optical sheets.

### EXAMPLE 3 OF PRODUCTION LINE FOR OPTICAL SHEETS FOR DISPLAYS

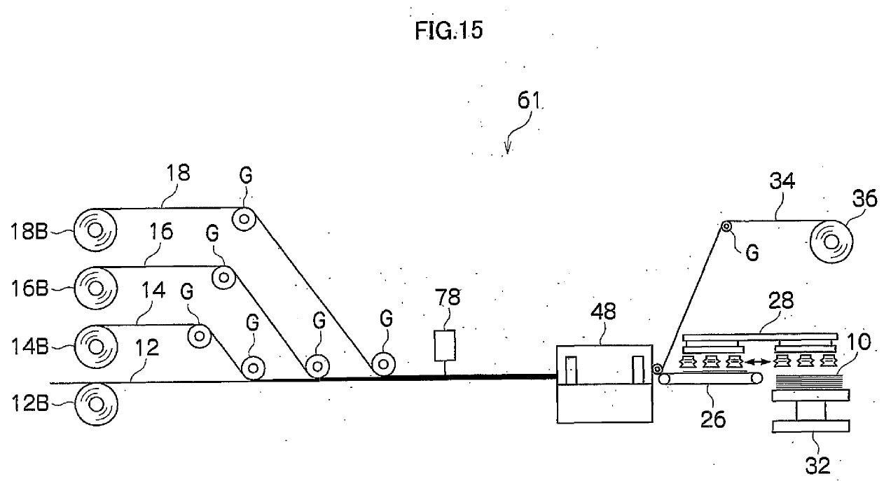

Next, still another example of the production line for optical sheets for displays will be described. FIG. 15 is a block diagram of a production line 61 for optical sheets for displays according to another embodiment. Incidentally, components identical with or similar to those of the production line 11 for optical sheets for displays in FIG. 13 and production line 51 for optical sheets for displays in FIG. 14 are denoted by the same reference numerals as the corresponding components in FIGS. 13 and 14, and detailed description thereof will be omitted.

The production line 61 for optical sheets for displays in FIG. 15 employs one laser head 78 instead of the three laser heads 72, 74, and 76 of the display optical sheets production line 51 in FIG. 14. The laser head 78 is installed downstream of press rollers (guide rollers G).

The laser head 78 is used to fuse two or more laminated sheets together. Specifically, the laser head 78 fuses the laminate of the first diffusion sheet 12, first prism sheet 14, second prism sheet 16, and second diffusion sheet 18 together.

Incidentally, the laser head 78 is used only in the bonding process while the cutting process is performed by the blanking press 48. However, basic specifications and peripheral configuration of the laser head 78 are approximately the same as in FIG. 13.

Conditions of the laser head 78 can be set such that the fused part will not be broken by heat and the bonded (fused) part may be cooled by blowing air from an air-cooling mechanism.

By making the blade of the blanking press 48 downstream of the laser head 78 pass through a central portion of the fused and bonded part, it is possible to bond edges on all or any desired sides of the blanked sheets (optical sheets 10 to 60 for displays) in the resulting compound optical sheets.

Next, description will be given of planar layout of the sheets (optical sheets 10 to 60 for displays) blanked from the laminate of the first diffusion sheet 12, first prism sheet 14, second prism sheet 16, and second diffusion sheet 18.

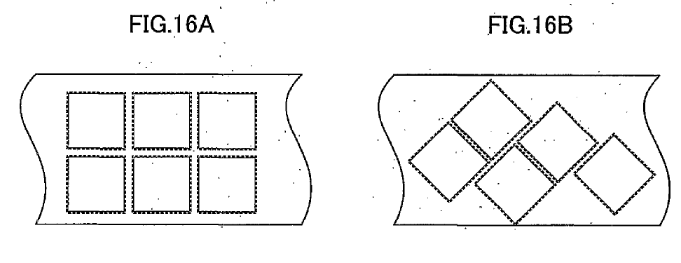

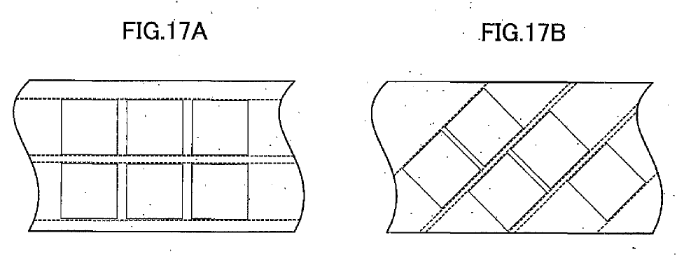

FIGS. 16A and 16B are diagrams illustrating a planar layout of sheets (optical sheets 10 to 60 for displays) blanked from a laminate on the production line 11 for optical sheets for displays illustrate in FIG. 13. FIGS. 17A and 17B are diagrams illustrating a planar layout of sheets (optical sheets 10 to 60 for displays) blanked from a laminate on the production lines 51 and 61 for optical sheets for displays illustrated in FIGS. 14 to 15.

FIG. 16A shows fusing (bonding process) and blanking (cutting process) in a direction parallel to the transport direction of the laminate and FIG. 16B shows fusing (bonding process) and blanking (cutting process) in a direction oblique to the transport direction of the laminate. In the figures, the dotted lines along the peripheral edges of the sheets blanked from laminates indicate fused points.

FIG. 17A shows fusing (bonding process) and blanking (cutting process) in a direction parallel and orthogonal to the transport direction of the laminate and FIG. 17B shows fusing or bonding (bonding process) in a direction oblique to the transport direction of the laminate. In the figures, the dotted lines along the peripheral edges of the sheets blanked from laminates indicate fused or bonded points.

[Second Form of Manufacturing Method]

Next, a second form of the manufacturing method will be described. Aside from a method of heating and bonding photothermal conversion material by laser irradiation, a method is available which applies ultrasonic vibrations to part desired to be bonded by means of an ultrasonic welder and bonds the part using frictional heat generated by the vibrations.

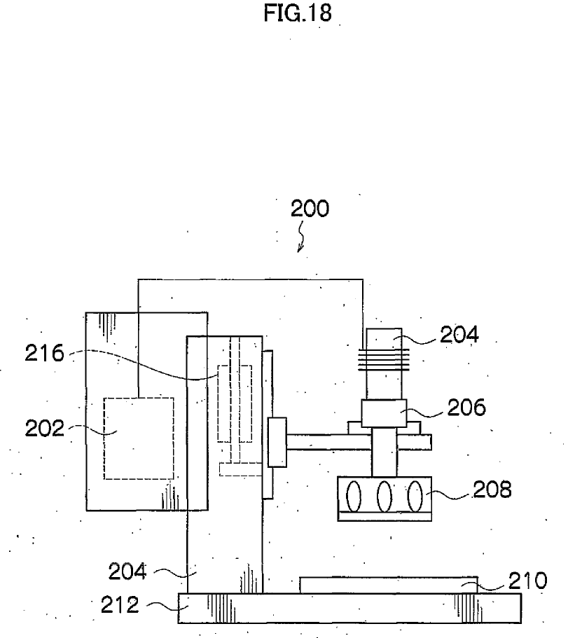

FIG. 18 is a block diagram of an ultrasonic welder. As illustrated in the figure, the ultrasonic welder 200 is equipped with an oscillator 202, vibrator 204, booster 206, ultrasonic horn 208, and base block 210. An air cylinder 216 is contained in a press column 214 erected on a surface plate 212. The air cylinder 216 can move up and down the ultrasonic horn 208.

With the ultrasonic welder 200 configured as described above, welding was performed using a power of 1 kW, welding force of 34 kg, and weld time of 1.2 seconds. As a result, bonding was achieved without any problem in appearance, bonding strength, or optical performance.

Although in the example illustrated here, a light diffusion sheet placed on top of a prism sheet is bonded, three sheets or four sheets can be bonded as well by adjusting the conditions of ultrasonic power, welding force, and pressurizing time. Besides, the optical sheets may be bonded by ultrasonic welding in twice, from the front side and back side.

Due to mechanical conditions, ultrasonic welding involves placing the material desired to be bonded between the ultrasonic horn 208 and base block 210. When bonding workpieces in motion (e.g., optical sheet material in transit) by the ultrasonic welder 200, it is desirable that the base block 210 should be provided with an up/down mechanism as in the case of the ultrasonic horn 208.

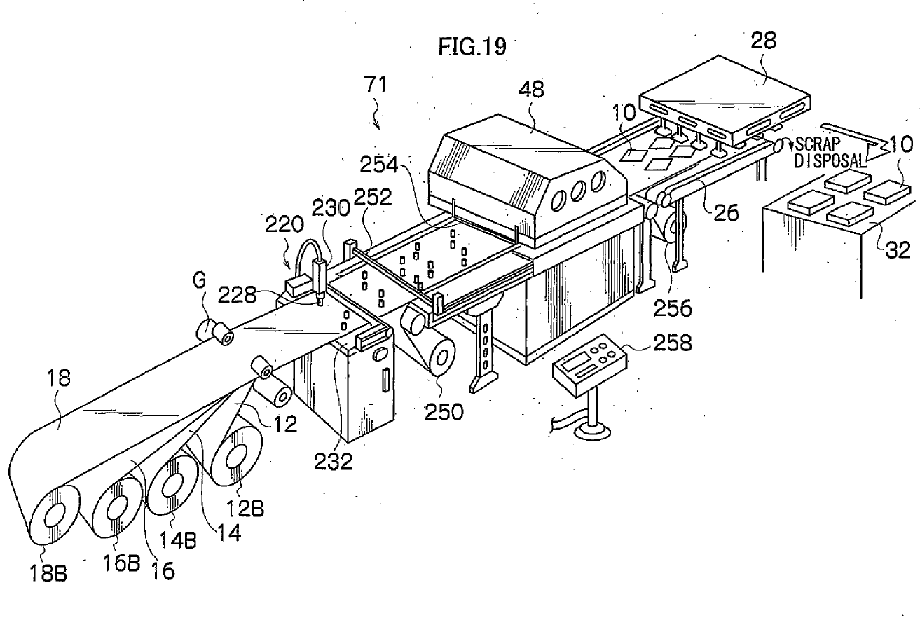

FIG. 19 shows an example of a production line for optical sheets for displays which employs a manufacturing process in which four types of rolled optical sheet are delivered in a pile and bonded by an ultrasonic welder before blanking.

### EXAMPLE 4 OF PRODUCTION LINE FOR OPTICAL SHEETS FOR DISPLAYS

In a production line 71 for optical sheets for displays in FIG. 19, components identical with or similar to those of the production line 61 for optical sheets for displays in FIG. 15 are denoted by the same reference numerals as the corresponding components in FIG. 15, and detailed description thereof will be omitted.

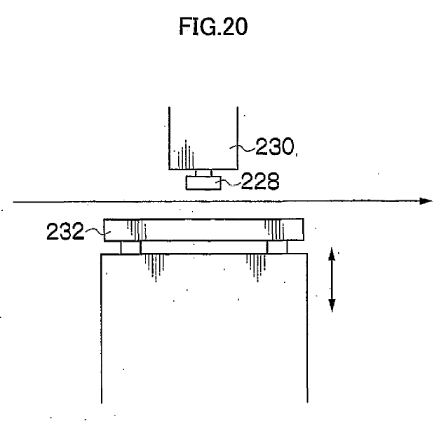

The production line 71 for optical sheets for displays in FIG. 19 employs an ultrasonic welder 220 instead of the laser head 78 of the production line 61 for optical sheets for displays illustrated in FIG. 15. An ultrasonic welding head 230 including an ultrasonic horn 228 is supported by an orthogonal X-Y travel mechanism. An anvil (base block) 232 placed opposite the ultrasonic welding head 230 can be moved up and down (see FIG. 20) by an up/down mechanism (not shown).

For welding, the workpieces are placed between the ultrasonic horn 228 and anvil 232 by raising the anvil 232. When transporting sheets without carrying out welding, the anvil 232 is lowered to a position (retracted position) clear of the workpieces. This prevents damage to the back side.

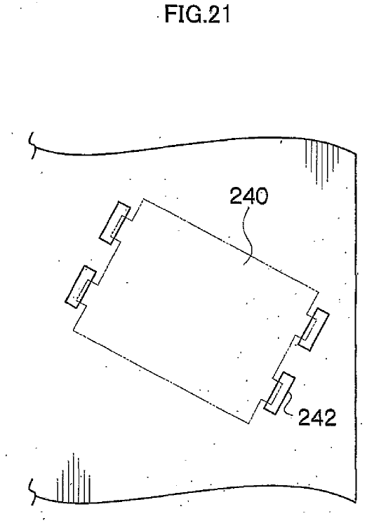

FIG. 21 is a plan view showing an example of welding performed by the welding head 230 shown in FIG. 19. An approximately rectangular area 240 (including four protrusions) enclosed by a two-dot chain line in FIG. 21 represents a shape (product shape) to be blanked on the press 48 in FIG. 19. Of the area to be blanked in FIG. 21, only the protrusions 242 (four locations) enclosed by solid lines are welded. After the protrusions 242 are welded, the optical sheet is blanked into the product shape on the press 48 in FIG. 19.

The optical sheets 10 of product size for displays are produced in this way. After the cutting and bonding on the press 48, the optical sheets 10 are transported on a conveyor 26. When the conveyor 26 stops, the optical sheets 10 on it are stacked one after another on an accumulation unit 32 by a horizontal transfer machine 28.

Incidentally, in FIG. 19, reference numeral 250 denotes a Lumirror delivery roll, 252 denotes a clamp slider, 254 denotes an ionizer, 256 denotes a wind-up roll, and 258 denotes a control panel.

### EXAMPLE 5 OF PRODUCTION LINE FOR OPTICAL SHEETS FOR DISPLAYS

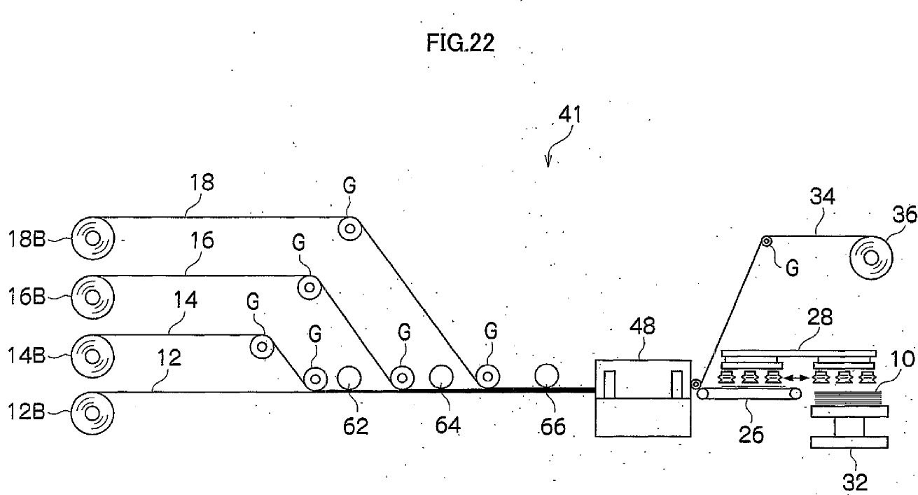

Next, still another example of the production line for optical sheets for displays will be described. FIG. 22 is a block diagram of another production line 41 for optical sheets for displays. Incidentally, components identical with or similar to those of the production line 11 for optical sheets for displays in FIG. 13 and production line 51 for optical sheets for displays in FIG. 14 are denoted by the same reference numerals as the corresponding components in FIGS. 13 and 14, and detailed description thereof will be omitted.

The production line 41 for optical sheets for displays in FIG. 22 employs ultrasonic horns 62, 64, and 66 instead of the laser heads 72, 74, and 76 of the display optical sheets production line 51 in FIG. 14. The ultrasonic horns 62, 64, and 66 are installed downstream of press rollers (guide rollers G).

The ultrasonic horns 62, 64, and 66 are used to fuse two or more laminated sheets together. Specifically, the ultrasonic horn 62 fuses the first diffusion sheet 12 and first prism sheet 14 together, the ultrasonic horn 64 fuses the first prism sheet 14 and second prism sheet 16 together, and the ultrasonic horn 66 fuses the second prism sheet 16 and second diffusion sheet 18 together.

Incidentally, respective up-and-down anvils are placed in opposing relation to the ultrasonic horns 62, 64, and 66 although they are not shown in the figure.

Regarding the ultrasonic horns 62, 64, and 66 (ultrasonic welders), a type which moves up and down a horn using an air cylinder (such as described above with reference FIG. 18) and a type which moves up and down a horn using a servo motor are known, but any type of ultrasonic horn may be used as long as it can fuse sheets together by applying ultrasonic vibrations to the sheets together with a load.

Regarding position control of the ultrasonic horns 62, 64, and 66 shown in FIG. 22, when a blanking pattern is parallel to the sheet feed direction, their positions need to be switched only in the width direction of the sheets. In the case of an oblique blanking pattern, the ultrasonic horns 62, 64, and 66 can be moved in the width direction according to the amount of travel using an oscillating mechanism which can change travel directions of the ultrasonic horns 62, 64, and 66 as required.

Conditions of the ultrasonic horns 62, 64, and 66 can be set such that the fused part will not be broken by heat and the bonded (fused) part may be cooled by blowing air from an air-cooling mechanism.

By making the blade of the blanking press 48 downstream of the ultrasonic horns 62, 64, and 66 pass through a central portion of the fused and bonded part, it is possible to bond edges on all or any desired sides of the blanked sheets (optical sheets 10 to 60 for displays) in the resulting compound optical sheets.

As described above, embodiments of the present invention make it possible to produce high-quality optical sheets for displays at low costs using simpler processes than conventional methods.

Also, the present invention provides the following advantages.

1) Reduction in Costs and Thickness Resulting in Increased Product's Value

Optical sheets used for large liquid crystal television sets require stiffness, making it necessary to use backing approximately twice as thick as conventional one. However, since the optical sheet according to the present invention is a combination of multiple sheets, it is possible to provide sufficient stiffness without increasing the thickness of individual layers. This makes it possible to reduce the thickness of individual layers.

2) Prevention of Decline in Light-Gathering Power Resulting in Improved Performance

The back sides of some tens sheets are matted to prevent damage (to make flaws less conspicuous). The optical sheet according to the present invention does not need matting. This reduces production costs, prevent decline in light-gathering power caused by matting, and thereby improves performance.

Embodiments of the manufacturing method of optical sheets for displays according to the present invention have been described above, but the present invention is not limited to the above embodiments and may take many other forms.

For example, although in all the above embodiments, prisms on the first prism sheet 14 and second prism sheet 16 face upward, the prism sheets may be laminated with the prisms facing downward.

Also, layer composition is not limited to those according to the above embodiments, and protective sheets may be placed on the top and bottom faces.

Such layer composition will operates in a similar manner and provides effects similar to the above embodiments.

Furthermore, in the first form of the manufacturing method (using laser) and second form of the manufacturing method (using ultrasonic waves), optical sheets may be processed in either of two orders: the optical sheets after the combination process may be blanked into a predetermined shape in the blanking process or sheets blanked into a predetermined shape in the blanking process may be glued together in the combination process.

Besides, the following compositions of optical sheets (orders in which they are laminated) are available.

[1] Composition of light diffusion sheet+lens sheet.

[2] Composition of light diffusion sheet+first tens sheet+second lens sheet.

In this case, it is preferable that the sheets will be bonded such that a ridge line of the first lens sheet will be at right angles, but the angle may be adjusted to prevent moire and the like.

[3] Composition of first light diffusion sheet+lens sheet+second light diffusion sheet.

[4] Composition of first light diffusion sheet+first lens sheet+second lens sheet+second light diffusion sheet.

[5] Composition of lens sheet+light diffusion sheet.

[6] Composition of first lens sheet+second lens sheet+light diffusion sheet.

The present invention is applicable to any of the compositions [1] to [6] described above.

### EXAMPLES

### Fabrication of Prism Sheet

A prism sheet for use as the first prism sheet 14 and second prism sheet 16 was fabricated. It is commonly used for the first prism sheet 14 and second prism sheet 16.

—Preparation of Resin Solution

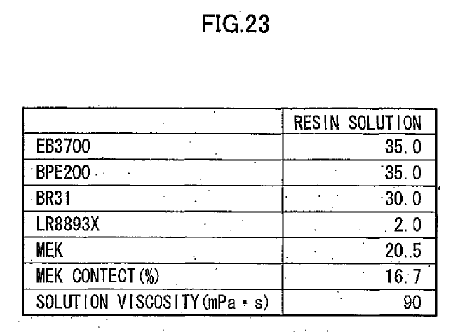

Compounds shown in a table in FIG. 23 were mixed in proportions by weight indicated in the table, and then the mixture was heated and resolved at 50° C. to obtain a resin solution. Names and details of the compounds are shown below.

EB3700: Ebecryl 3700 (Bisphenol-A epoxy diacrylate) manufactured by Daicel UC, Co., Ltd.; (Viscosity: 2200 mPa·s/65° C.)

BPE200: NK Ester BPE-200 (ethylene oxide modified Bisphenol-A methacrylate) manufactured by SHIN-NAKAMURA CHEMICAL CO., LTD.; (Viscosity: 590 mPa·s/65° C.)

BR-31: NEW FRONTIER BR-31 (tribromophenoxy ethyl acrylate) manufactured by DAIICHI KOGYO SEIYAKU CO., LTD.; (Solid at room temperature; melting point: 50° C. or above)

LR8893X: Lucirin LR8893X (ethyl-2,4,6-trimethylbenzoylphenyl phosphineoxide which is a radical generator) manufactured by BASF Corp.

MEK: methyl ethyl ketone

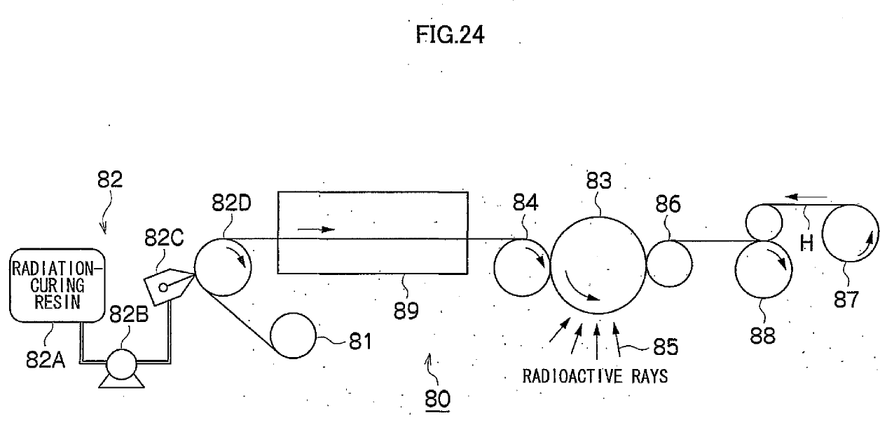

Prism sheets were produced using prism sheet manufacturing equipment of the configuration shown in FIG. 24.

A transparent PET (polyethylene terephthalate) film 500 mm in width and 100 μm in thickness was used as a sheet W.

An emboss roller 83 with a length of 700 mm (in the width direction of the sheet W) and a diameter of 300 mm was used. It was made of S45C and plated with nickel. A groove with a pitch of 50 μm was cut along the roller axis with a diamond cutter (single-point) over a length of approximately 500 mm around the entire circumference of the roller. A cross-sectional shape of the groove is triangular with an apical angle of 90 degrees. The bottom of the groove is also triangular without a flat part and with an apical angle of 90 degrees. That is, the groove is 50 μm wide and approximately 25 μm deep. The groove is an endless groove without any seam in the circumferential direction of the roller. Thus, lenticular lenses (prism sheet) can be formed with the emboss roller 83. After the groove-cutting, the surface of the roller was plated with nickel.

A dye coater with an extrusion type coating head 82C was used as a coating means 82.

A liquid of the composition shown in the table in FIG. 23 was used as a coating liquid F (resin solution). An amount of coating liquid F supplied to a coating head 82C was controlled by a feeder 82B so that film thickness of the coating liquid F (resin solution) after an organic solvent dried would be 20 μm.

A circulating hot air drier was used as a drying means 89. Temperature of the hot air was 100° C.

A 200-mm diameter roller covered with a silicone rubber layer with a rubber hardness of 90 was used as a nip roller 84. Nip pressure (effective nip pressure) at which the sheet W was pressed between the emboss roller 83 and nip roller 84 was 0.5 Pa.

A metal halide lamp was used as a resin hardening means 85. It illuminated with an energy of 1000 mJ/cm².

Consequently, a prism sheet with a concavo-convex pattern was obtained.

[Fabrication of First Diffusion Sheet 12]

An undercoat layer, backcoat layer, and light diffusion layer were formed in order by the following method, and thereby a first diffusion sheet 12 (lower diffusion sheet) was fabricated.

—Undercoat Layer

One side of a polyethylene terephthalate film (backing) 100 μm in thickness was coated with liquid A, which was an undercoat liquid of the following composition, using a wire bar (wire size: #10), and an undercoat layer 1.5 μm in film thickness was obtained after drying at 120° C. for 2 minutes.

(Undercoat liquid)

| | | |
|---|---|---|
| Methanol | 4,165 | g |
| JURYMER-SP-50T (manufactured by Nihon Junyaku Co., | 1,495 | g |
| Ltd.) | | |
| Cyclohexanone | 339 | g |
| JURYMER-MB-1X (manufactured by Nihon Junyaku Co., | 1.85 | g |
| Ltd.) (Organic particles: crosslinked polymethyl | | |
| methacrylate - spherical ultrafine particles with | | |
| a weight-average particle diameter of 6.2 μm) | | |

—Backcoat Layer

The surface on the other side of the backing from the undercoat layer was coated with liquid B, which was a backcoat liquid of the following composition, using a wire bar (wire size: #10), and a backcoat layer 2.0 μm in film thickness was obtained after drying at 120° C. for 2 minutes.

(Backcoat liquid)

| | | |
|---|---|---|
| Methanol | 4,171 | g |
| JURYMER-SP-65T (manufactured by Nihon Junyaku Co., | 1,487 | g |
| Ltd.) | | |
| Cyclohexanone | 340 | g |
| JURYMER-MB-1X (manufactured by Nihon Junyaku Co., | 2.68 | g |
| Ltd.) (Organic particles: crosslinked polymethyl | | |
| methacrylate - spherical ultrafine particles with | | |
| a weight-average particle diameter of 6.2 μm) | | |

—Light diffusion layer

The undercoated surface of the backing fabricated above was coated with liquid C, which was a light diffusion liquid of the following composition, using a wire bar (wire size: #22), and a light diffusion layer was obtained after drying at 120° C. for 2 minutes. Incidentally, as described later, light diffusion layers were obtained in two ways: by applying the liquid C either immediately after preparation or after two hours of rest.

(Light diffusion liquid)

| | | |
|---|---|---|
| Cyclohexanone | 20.84 | g |
| DISPARLON PFA-230 (with solids concentration of | 0.74 | g |
| 20% by mass) (Anti-settling agent: fatty amide | | |
| manufactured by Kusumoto Chemicals, Ltd.) | | |
| Acrylic resin (DIANAL BR-117 manufactured by | 17.85 | g |
| Mitsubishi Rayon Co., Ltd.) - 20% by mass in methyl | | |
| ethyl ketone solution | | |
| JURYMER-MB-20X (manufactured by Nihon Junyaku | 11.29 | g |
| Co., Ltd.) (Organic particles: crosslinked | | |
| polymethyl methacrylate - spherical ultrafine | | |
| particles with a weight-average particle diameter | | |
| of 18 μm) | | |
| F780F (Dainippon Ink and Chemicals, Inc.) | 0.03 | g |
| (30% by mass in methyl ethyl ketone solution) | | |

[Fabrication of Second Diffusion Sheet 18]

The second diffusion sheet 18 (upper diffusion sheet) was fabricated using the same procedures and same conditions as the first diffusion sheet 12 except that 1.13 g of JURYMER-MB-20X was added instead of 11.29 g.

Fabrication of Optical Sheet 10 for Displays

### Example

The optical sheet 10 (optical sheet module) for displays shown in FIG. 1 was fabricated by using the sheets fabricated above and laminating the first diffusion sheet 12, first prism sheet 14, second prism sheet 16, and second diffusion sheet 18 in this order from the bottom.

The production line 11 for optical sheets for displays shown in FIG. 13 was used as the manufacturing equipment. A carbon dioxide laser gun was used as the laser gun including the laser head 24. Its wavelength was 10 μm, power was 25 W, and frequency was 50 kHz.

The fabrication method of the optical sheet 10 (optical sheet module) for displays involved cutting and bonding four edges of the laminated sheet by laser irradiation.

Fabrication of Optical Sheet for Displays

### Comparative Example

An optical sheet for displays was fabricated by cutting each of the sheets (first diffusion sheet 12, first prism sheet 14, second prism sheet 16, and second diffusion sheet 18) separately into product size and stacking and bonding the sheets one by one.

[Evaluation of Optical Sheets for Displays]

One hundred (100) sets each of the optical sheets for displays according to the example and comparative example were installed in a liquid crystal device and checked for a flaw-induced failure. If a bright line caused by a flaw was recognized, the given set of optical sheets was determined to be defective.

Only 1 set out of 100 sets in the example was defective. On the other hand, 24 sets out of 100 sets in the comparative example were defective. This confirms that the example according to the present invention can greatly reduce flaw-induced failures.

1. A manufacturing method of optical sheets for displays, comprising:
a lamination step of laminating a plurality of optical sheets; and
a bonding step of irradiating at least one or more spots on a laminate of the optical sheets prepared in the lamination step with a laser beam from one side of the laminate and thereby bonding the irradiated spots to obtain a compound optical sheet in which the plurality of optical sheets are integrated.

2. The manufacturing method of optical sheets for displays according to claim 1, further comprising a photothermal conversion layer forming step of forming a photothermal conversion layer from a laser absorber between the optical sheets bonded by irradiation with the laser beam.

3. A manufacturing method of optical sheets for displays, comprising:
a lamination step of laminating a plurality of optical sheets; and
a bonding step of pressing a horn against at least one or more spots on a laminate of the optical sheets prepared in the lamination step from one side of the laminate and thereby bonding the spots to obtain a compound optical sheet in which the plurality of optical sheets are integrated.

4. The manufacturing method of optical sheets for displays according to claim 3, further comprising a base block up/down step of raising and lowering a base block placed in opposing relation to the horn.

5. The manufacturing method of optical sheets for displays according to claim 1, wherein the plurality of optical sheets are two or more optical sheets including at least one light diffusion sheet and at least one lens sheet.

6. The manufacturing method of optical sheets for displays according to claim 3, wherein the plurality of optical sheets are two or more optical sheets including at least one light diffusion sheet and at least one lens sheet.

7. The manufacturing method of optical sheets for displays according to claim 1, wherein:
each of the plurality of optical sheets has a planar size larger than product size; and
the manufacturing method further comprises a cutting step of cutting the compound optical sheet obtained in the bonding process into the product size.

8. The manufacturing method of optical sheets for displays according to claim 3, wherein:
each of the plurality of optical sheets has a planar size larger than product size; and
the manufacturing method further comprises a cutting step of cutting the compound optical sheet obtained in the bonding process into the product size.
